(19) United States
(12) Patent Application Publication
(10) Pub. No.: US 2016/0172834 A1
(43) Pub. Date: Jun. 16, 2016

(54) Releasable Messenger Clamp

(71) Applicant: Drexel University, Philadelphia, PA (US)

(72) Inventors: Luke Larry Fox, Elizabethtown, PA (US); Jason Samuel Gottlieb, Leesburg, VA (US); Kevin William James, Hatboro, PA (US); Patrick Thomas Kennedy, Doylestown, PA (US); Lok Ngan, Warminster, PA (US)

(21) Appl. No.: 14/571,321

(22) Filed: Dec. 16, 2014

(51) Int. Cl. H02G 7/05

(52) U.S. Cl. CPC H02G 7/053

(57) ABSTRACT

A messenger wire clamp is disclosed. The clamp includes an interface portion adapted to be fixedly connected to a support bracket and a wire clamping portion releasably connected to the interface portion. The wire clamping portion has a wire retaining passage extending longitudinally therealong. A securing device extends laterally though the wire clamping portion and into the interface portion. The securing device releasably secures the wire clamping portion to the interface portion.

### BACKGROUND OF THE INVENTION

Aerial electrical distribution systems use electrical wires strung from vertical poles transmit electricity over distances. Severe weather events, such as high winds and ice storms can stress these distribution systems to the point of failure. Falling tree branches or excessive ice build-up can break poles and/or wires, resulting in lengthy disruptions of electrical service, which can take days and cost thousands of dollars to repair.

It would be beneficial to provide a connection system between the pole and the supported wires such that, upon experiencing an excessive weight load, the wires separate from the pole, reducing the risk of breakage of the pole and the wires.

### BRIEF SUMMARY OF THE INVENTION

Briefly, the present invention provides a messenger wire clamp comprising an interface portion adapted to be fixedly connected to a support bracket and a wire clamping portion releasably connected to the interface portion. The wire clamping portion has a wire retaining passage extending longitudinally therealong. A securing device extends laterally though the wire clamping portion and into the interface portion. The securing device releasably secures the wire clamping portion to the interface portion.

Additionally, the present invention provides a wire messenger clamp comprising a generally parallelepiped interface portion having a body. The body has a bottom surface and a front surface. The front surface has an upper portion having a bolt hole extending laterally therethrough and a lower portion located below the upper portion. The lower portion has a T-bolt slot extending vertically into the body and downward to the bottom surface. A generally parallelepiped wire clamping plate is releasably coupled to the interface portion. The wire clamping plate has a planar inner face engaged with the lower portion of the interface portion. The inner face includes a plurality of longitudinally extending passages. Each passage has a generally semi-circular cross section, such that at least one of the plurality of passages is adapted to receive and retain a wire between the interface portion and the wire clamping plate.

Further, the present invention provides a wire messenger clamp comprising an interface portion having a generally parallelepiped body having a front surface, a bottom surface, and a T-bolt slot formed therein. The T-bolt slot extends laterally through the front surface and through the bottom surface. A wire clamping plate has a T-bolt hole formed laterally therethrough. A T-bolt is inserted into the T-bolt slot and extends through the T-bolt hole in the wire clamping plate. The T-bolt releasably secures the wire clamping plate to the interface portion.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 shows a perspective view of a releasable messenger clamp according to a first exemplary embodiment of the present invention, installed on a pole bracket;

FIG. 2 shows a bottom plan view of the clamp and bracket of FIG. 1;

FIG. 3 shows a rear perspective view of the clamp of FIG. 1;

FIG. 4 shows a bottom plan view of the clamp of FIG. 1;

FIG. 5 shows side elevational view, in section, of the clamp and bracket of FIG. 1, with the clamp sectioned along a vertical lateral plane;

FIG. 5A is a rear perspective view of a wire clamping plate used with the clamp of FIG. 1;

FIG. 6 shows a perspective view of an alternative embodiment of a releasable messenger clamp according to a second exemplary embodiment of the present invention; and

FIG. 7 is a graph of torque applied to secure the clamp of FIG. 1 vs. force required to separate the clamp at that torque value.

### DETAILED DESCRIPTION

In the drawings, like numerals indicate like elements throughout. Certain terminology is used herein for convenience only and is not to be taken as a limitation on the present invention. The terminology includes the words specifically mentioned, derivatives thereof and words of similar import. The embodiments illustrated below are not intended to be exhaustive or to limit the invention to the precise form disclosed. These embodiments are chosen and described to best explain the principle of the invention and its application and practical use and to enable others skilled in the art to best utilize the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein, the term “longitudinal” is defined as the direction of run of a wire supported by the clamp of the present invention and “lateral” is defined as a direction perpendicular to “lateral”, in a direction along the length of a support bracket used to support the clamp of the present invention.

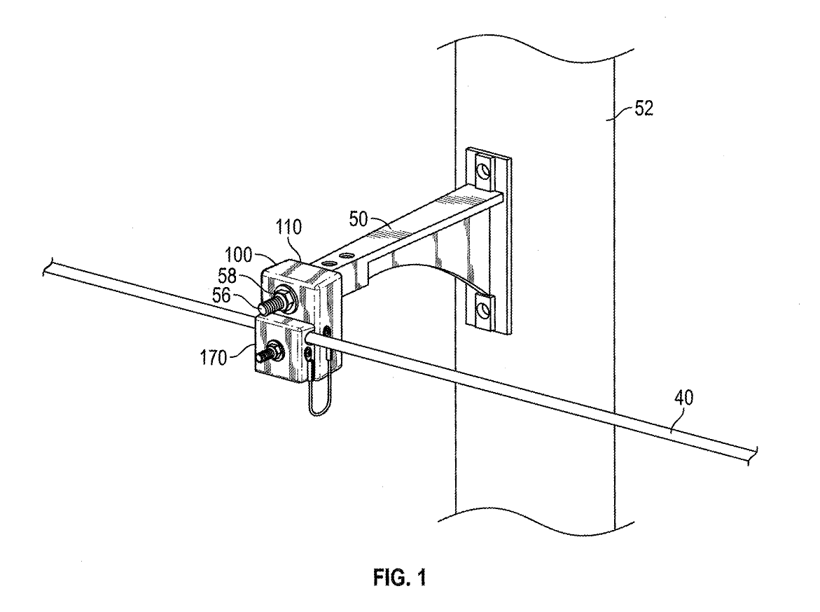

Referring to the Figures, a releasable messenger clamp (“clamp”) 100 according to a first exemplary embodiment of the present invention is shown. Clamp 100 releasably secures a messenger wire 40 to a support structure, such as, for example, a bracket 50 on a vertical utility pole 52 (shown in FIG. 1).

Clamp 100 releases wire 40 from bracket 50 when an excessive downward force is applied to wire 40, such as, for example, when a broken tree branch falls against wire 40 or when excessive ice builds up on wire 40. The release of wire 40 from bracket 50 reduces the likelihood of wire 40 or pole 52 snapping as a result of the excessive force applied to wire 40.

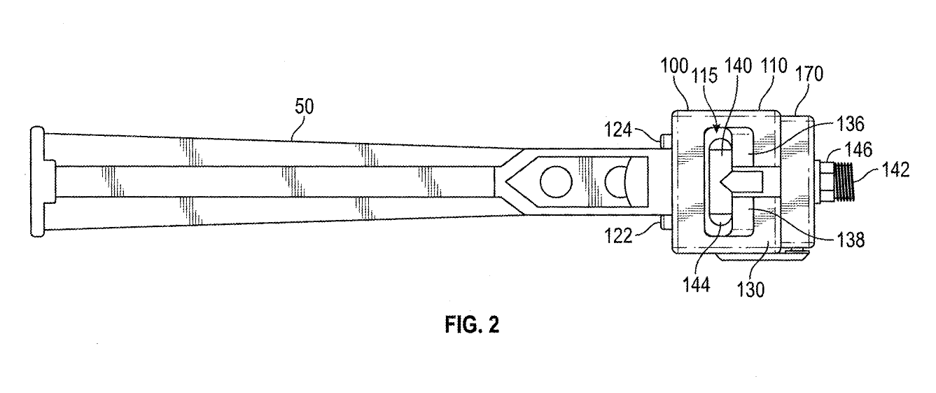

Referring to FIGS. 2-5, clamp 100 is comprised of an interface portion 110 and a wire clamping plate 170 releasably secured to interface portion 110. Interface portion 110 is a generally parallelepiped structure, with passages formed therethrough. The passages accommodate bolts to secure interface portion 110 to wire clamping plate 170, as well as to bracket 50.

Interface portion 110 includes a front surface 112 that has a lower portion 114 adapted to engage clamping plate 170. A T-bolt slot 115 extends vertically through lower portion 114 into the body of interface portion 110 and downward to a bottom surface 130 of interface portion 110. Front surface 112 also includes an upper portion 116 having a bolt hole 118 extending laterally therethrough. Bolt hole 118 is sized to allow a threaded rod 56 extending laterally outwardly from bracket 50 such that interface portion 110 can be slid over threaded rod 56 and secured to threaded rod 56 via a flange hex locknut 58, as shown in FIG. 2.

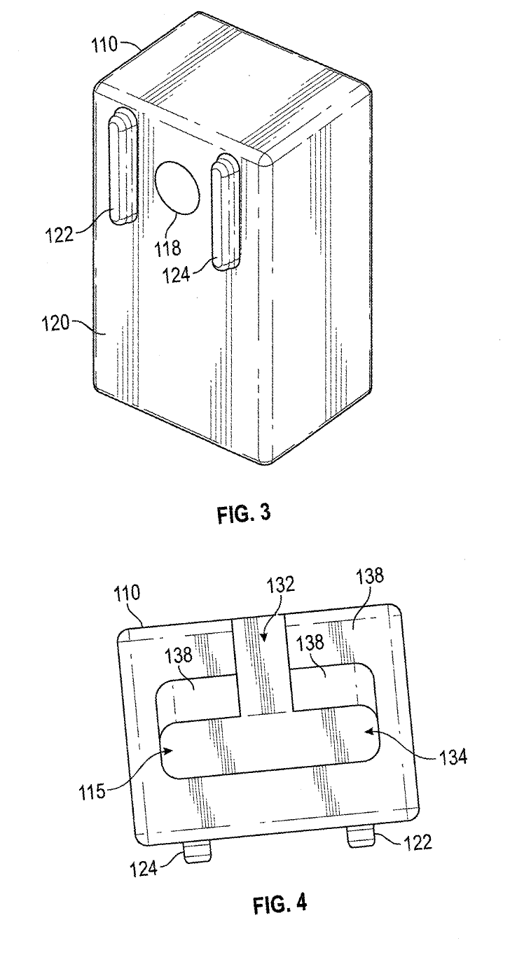

Referring to FIG. 3, interface portion 110 also includes a rear surface 120 that engages bracket 50. Bolt hole 118 extends through rear surface 120. Rear surface 120 include a pair of generally parallel spacer ribs 122, 124 spaced sufficiently far apart to allow an end face of bracket 50 to be inserted therebetween in order to align clamp 100 onto end of bracket 50.

Referring to FIG. 4, interface portion 110 also includes a bottom surface 130 through which T-bolt slot 115 extends. T-bolt slot 115 includes a narrow forward portion 132 having an opening sized to accommodate a lateral portion 142 of a T-bolt 140 and a wider rear portion 134 having an opening sized to accommodate longitudinal portion 144 of T-bolt 140.

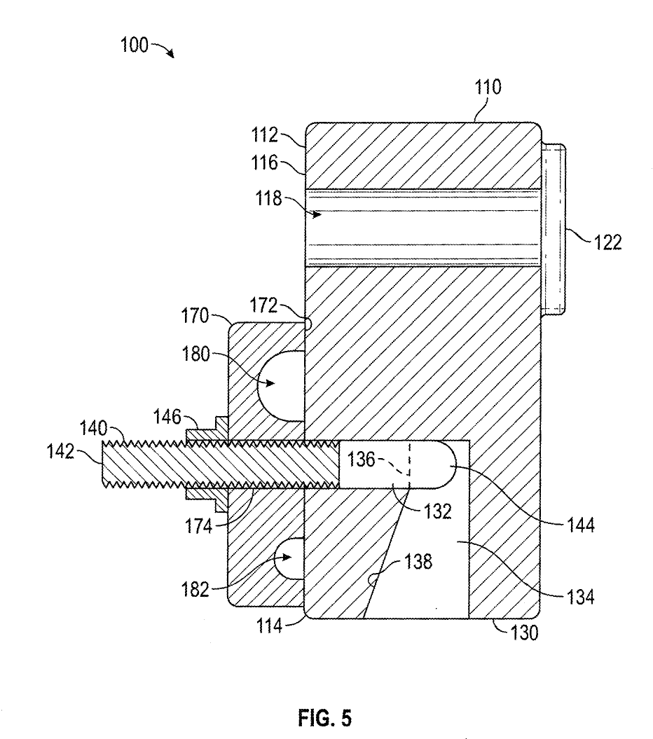

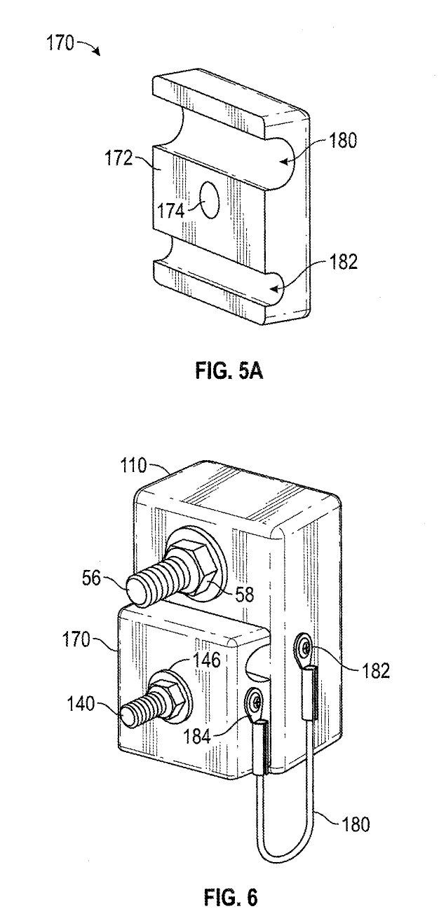

As shown in phantom lines in FIGS. 2 and 5, rear portion 134 has a forward wall 136 that extends vertically downwardly toward bottom surface 130. Longitudinal portion 144 of T-bolt 140 engages and is forced against forward wall 136 when wire clamping plate 170 is secured to interface portion 110. A lower wall 138 extends downwardly from forward wall 136 in an oblique direction toward lower portion 114 of front surface 112, increasing the size of T-bolt slot 115 approaching bottom surface 130.

Referring to FIGS. 1, 2, 5, and 5A, wire clamping plate 170 is a generally parallelepiped structure having a planar inner face 172 that engages front surface 112 of interface portion 110 below threaded rod 56. Inner face 172 includes a plurality of longitudinally extending passages 180, 182, each having generally semi-circular cross sections, that receive and retain wire 40. Passage 180 has a first radius and passage 182 has a second radius, larger than the first radius. The differing radius sizes for first passage 180 and second passage 182 allow for messenger wires 140 of differing radii to be supported by clamp 100.

Wire clamping plate 170 also includes a laterally extending T-bolt passage 174 that aligns with T-bolt slot 115 along lower portion 114 of front surface 112 when T-bolt 140 is inserted into T-bolt passage 174. A flange hex nut 146 is threaded over lateral portion 142 of T-bolt 140 to frictionally secure wire clamping plate 170 to interface portion 110. The degree of tightness of the frictional engagement between wire clamping plate 170 and interface portion 110 determines the amount of vertical force required to be applied to messenger wire 40 to pull wire clamping plate 170 downward to release wire clamping plate 170 from interface portion 110 and allow messenger wire 40 to fall away from bracket 50 and pole 52.

In an exemplary embodiment, interface portion 110 and wire clamping plate 170 can be constructed from cast iron for strength and durability. Alternatively, interface portion 110 and wire clamping plate 170 can be constructed from cast or machined aluminum blocks, such as, for example, 6061 aluminum, to reduce weight. For any material, front surface 112 of interface block 110 and T-bolt slot 115 can be machined.

While, in the exemplary embodiment disclosed, interface portion 110 is constructed from a single block, those skilled in the art will recognize that interface portion 110 can be formed from multiple pieces connected together, such as, for example, with bolts or other known securing devices.

Optionally, as shown in FIG. 6, a retainer cable 180 can have a first end 182 fixedly connected to interface portion 110 and a second end 184 fixedly connected to wire clamping plate 170 such that, when wire clamping plate 170 falls away from interface portion 110, such as when wire 40 pull wire clamping plate 170 downwardly as a result of excessive weight applied to wire 40, wire clamping plate 170 does not fall away from interface portion 110 and possibly become lost.

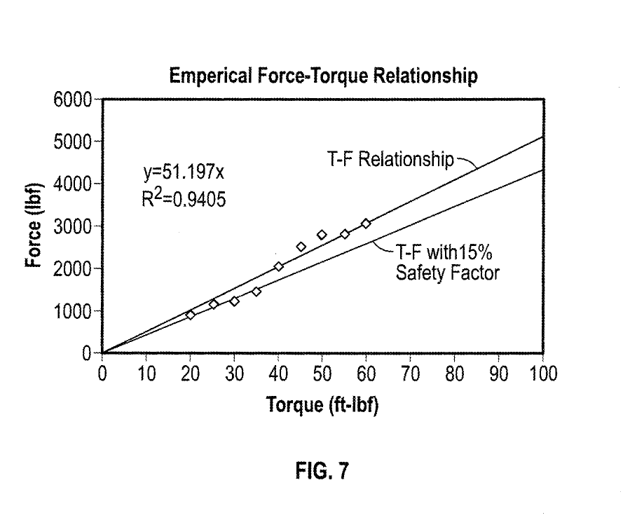

To install clamp 100 and wire 40 onto bracket 50, interface portion 110 is secured to bracket 50 as discussed above with respect to threaded rod 56. With T-bolt 140 inserted into T-bolt slot 115, wire 40 is inserted into its respective passage 180, 182, and wire clamping plate 170 is inserted over T-bolt 140 by sliding T-bolt passage 174 over lateral portion 142 of T-bolt 140 and securing wire clamping plate 170 to interface portion 110 by then inserting flange hex nut 146 over lateral portion 142 of T-bolt 140 and tightening flange hex nut 146 so that inner face 172 of wire clamping plate 170 frictionally engages lower portion 114 of interface portion 110. It is desired that the passage 180, 182 into which messenger wire 40 is inserted be located above T-bolt 140, as shown in FIG. 1. In the event that messenger wire 40 is inserted through passage 182, wire clamping plate is rotated 180 degrees about the axis of T-bolt 140 so that passage 182 is located above T-bolt 140. In an exemplary embodiment, about 20 ft-lb of torque is required to retain wire clamping plate 170 onto interface portion 110, and release when a 1,200 lb downward force (such as by a falling tree limb) is applied to messenger wire 40. A graph illustrating an empirical torque-forced relationship between the amount of torque to be applied to retain wire clamping plate 170 onto interface portion 110 versus the amount of force required to overcome that torque is provided in FIG. 7.

In operation, when sufficient downward force is applied to either or both of wire 40, wire 40 pull downwardly on wire clamping plate 170, overcoming the frictional force retaining wire clamping plate 170 onto interface portion 110, and releasing wire clamping plate 170 from interface portion 110, allowing wire 40 to fall freely from bracket 50 and pole 52. The oblique direction of lower wall 138 of T-bolt slot 115 allows T-bolt 140 to fall freely downwardly through T-bolt slot 115, and out from lower surface 130 to ensure that T-bolt 140 does not get “hung up” within T-bolt slot 115 and prevent full release of wire clamping plate 170 from interface portion 110.

If retainer cable (shown in FIG. 6) is used, retainer cable 180 prevents wire clamping plate 170 from falling away from interface portion 110 when wire clamping portion 170 is released from interface portion 110.

It will be further understood that various changes in the details, materials, and arrangements of the parts which have been described and illustrated in order to explain the nature of this invention may be made by those skilled in the art without departing from the scope of the invention as expressed in the following claims.

What is claimed is:

1. A messenger wire clamp comprising:
an interface portion adapted to be fixedly connected to a support bracket;
a wire clamping portion releasably connected to the interface portion, the wire clamping portion having a wire retaining passage extending longitudinally therealong; and
a securing device extending laterally though the wire clamping portion and into the interface portion, the securing device releasably securing the wire clamping portion to the interface portion.

2. The messenger wire clamp according to claim 1, wherein the interface portion comprises a bottom face having an opening sized to allow the securing device to fall vertically therethrough.

3. The messenger wire clamp according to claim 1, wherein the wire retaining passage extends vertically above the securing device.

4. The messenger wire clamp according to claim 3, further comprising a second wire retaining passage extending longitudinally below the securing device.

5. The messenger wire clamp according to claim 4, wherein the wire retaining passage has a first radius and the second wire retaining passage has a second radius, smaller than the first radius.

6. The messenger wire clamp according to claim 1, wherein the securing device comprises a T-bolt.

7. The messenger wire clamp according to claim 1, wherein the interface portion comprises a through-opening extending laterally therethrough, the through-opening sized to engage the support bracket.

8. The messenger wire clamp according to claim 1, wherein the wire retaining passage includes an open face in engagement with the interface portion.

9. A wire messenger clamp comprising:
a generally parallelepiped interface portion having a body, the body having a bottom surface and a front surface, the front surface having:
an upper portion having a bolt hole extending laterally therethrough; and
a lower portion located below the upper portion, the lower portion having a T-bolt slot extending vertically into the body and downward to the bottom surface;
a generally parallelepiped wire clamping plate releasably coupled to the interface portion, the wire clamping plate having a planar inner face engaged with the lower portion of the interface portion, the inner face including a plurality of longitudinally extending passages, each passage having a generally semi-circular cross section, such that at least one of the plurality of passages is adapted to receive and retain a wire between the interface portion and the wire clamping plate.

10. The wire messenger clamp according to claim 9, wherein the wire clamping plate has a T-bolt hole extending laterally therethrough and aligned with the T-bolt slot such that a T-bolt is insertable through the T-bolt slot and the T-bolt hole.

11. The wire messenger clamp according to claim 10, wherein the T-bolt hole extends parallel to the bolt hole.

12. The wire messenger clamp according to claim 10, wherein the T-bolt slot comprises a forward portion and a rear portion, wider than the forward portion, having a forward wall extending vertically downwardly toward the bottom surface and an oblique wall extending downwardly from the forward wall in an oblique direction toward the lower portion of front surface.

13. The wire messenger clamp according to claim 12, further comprising a T-bolt inserted into the T-bolt slot such that a longitudinal portion of the T-bolt extends in the rear portion and a lateral portion of the T-bolt extends in the forward portion.

14. The wire messenger clamp according to claim 13, wherein the lateral portion of the T-bolt extends through the T-bolt hole.

15. The wire messenger clamp according to claim 9, wherein at least one of the plurality of longitudinally extending passages has a radius greater than another of the plurality of longitudinally extending passages.

16. The wire messenger clamp according to claim 9, wherein the body of the interface portion comprises a rear surface, the rear surface having a pair of generally parallel spacer ribs extending outwardly therefrom.

17. The wire messenger clamp according to claim 16, wherein the bolt hole extends between the pair of spacer ribs.

18. A wire messenger clamp comprising:
an interface portion having a generally parallelepiped body having a front surface, a bottom surface, and a T-bolt slot formed therein, the T-bolt slot extending laterally through the front surface and through the bottom surface;
a wire clamping plate having a T-bolt hole formed laterally therethrough; and
a T-bolt inserted into the T-bolt slot and extending through the T-bolt hole in the wire clamping plate, the T-bolt releasably securing the wire clamping plate to the interface portion.

19. The wire messenger clamp according to claim 18, wherein the wire clamping plate includes at least one longitudinal passage extending therethough, the at least one longitudinal passage being defined by the wire clamping plate and the front surface of the interface portion.

20. The wire messenger clamp according to claim 18, wherein the T-bolt slot comprises an oblique surface extending downwardly toward the front surface.
